(19) United States
(12) Patent Application Publication
(10) Pub. No.: US 2005/0049790 A1
(43) Pub. Date: Mar. 3, 2005

(54) System and method for validating whether a software application is properly installed

(75) Inventors: Joseph R. Holman, Kirkland, WA (US); Jordan Tigani, Seattle, WA (US); Huy Vu-Bao Hoang, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/654,208

(22) Filed: Sep. 3, 2003

(51) Int. Cl. G06F 19/00; G06F 169/00

(52) U.S. Cl. 702/3

(57) ABSTRACT

A system and method for validating whether a software application is properly installed on a computer is presented. After the software application is installed on the computer, a validation manifest corresponding to the software application is obtained. A validation manifest is comprised of validation actions and other information, which, when executed and/or carried out, are used to determine whether the software application is properly installed. The results of executing and/or carrying out the validation actions are evaluated to determine whether an aspect of the software application is properly installed.

### FIELD OF THE INVENTION

The present invention relates to computer software and, in particular, to validating the installation of computer software on a computer.

### BACKGROUND OF THE INVENTION

Given the configurability, complexity, and sophistication of most software applications available today, it is a challenging task to ensure that software applications are properly installed a computer. Ensuring that an operating system is properly installed is even more particularly challenging given the almost innumerable array of hardware components/devices that can be used to make up a computer. In spite of these challenges, if software is installed on a computer, the computer's user will have an expectation that the software was installed properly and is ready to run.

Most computers are purchased with software already installed, or preinstalled. In fact, it is very difficult to purchase a computer without at least an operating system installed. In addition to the operating system, most new computers are also bundled with a variety of other software applications, such as a Web browser, an email program, a word processor, and the like. However, the operating system and these bundled applications are not preinstalled on the new computer in a “typical” manner, i.e., where a user installs the application onto the computer from a distribution CD. Instead, the computer vendor will typically have a master installation drive upon which the operating system and other bundled applications have been installed. Then, for each new computer sold, the master installation drive is then copied, verbatim, onto the hard drive of the new computer using a special, high-speed disk drive copying device. However, while the software on the master installation drive may have been installed in the typical manner, it is difficult to determine whether the installations were successful or not because the master installations cannot be executed/tested to verify that they are properly installed.

Typically, when software applications are executed for the very first time, a startup process is executed to complete the initialization and customization of the software installation. Frequently, these startup processes customize the installed software to the computer upon which they are installed. For example, environment variables may be set, search paths established, and default directories created. In an operating system's startup process, the operating system will typically generate a unique system identification number (SID) based on the hardware configurations, hardware serial numbers, network connections, and the like. The SID is used by the operating system to uniquely identify itself in a networked environment. The SID may also be used for registration purposes. Accordingly, the SID is permanently associated with, and used by the operating system. Thus, the master installation cannot be run a first time because it would generate the SID for the master computer, not the end user's computer, and the customizations and personalizations of the master computer would be duplicated to new computers. If this occurred, each new computer would have the same SID, which would be grievous to every network administrator.

Therefore, what is needed is a system and method to determine whether a software application is properly installed on a computer.

### SUMMARY OF THE INVENTION

In accordance with the present invention, a system and method for validating whether a software application is properly installed on a target computer is presented. A validation manifest corresponding to the software application is obtained. The validation manifest comprises validation actions for determining whether the software application is properly installed. Based on the results of executing the validation actions listed in the validation manifest, a determination is made as to whether the software application is properly installed.

In accordance with further aspects of the present invention, a computer networked environment for determining whether a software application is properly installed on a client computer is presented. A network administrator computer obtains a validation manifest corresponding to the software application on the client computer. The validation manifest comprises validation actions for determining whether the software application is properly installed on the client computer. Based on the results of executing the validation actions listed in the validation manifest, a determination is made as to whether the software application is properly installed on the client computer.

In accordance with yet further aspects of the present invention, a computer implemented method for determining whether a plurality of software applications installed on a target computer are properly installed. The plurality of software applications are identified. A validation manifest is obtained for each identified software application. The validation manifests comprises validation actions for determining whether the corresponding software application is properly installed on the client computer. For each identified software application, the validation actions in the corresponding validation manifest are carried out. For each identified software application, based on the results of executing the validation actions listed in the validation manifest, a determination is made as to whether the software application is properly installed on the client computer.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary computer system suitable for implementing aspects of the present invention;

FIG. 2 is a block diagram illustrating an exemplary installation and validation process of a software application in accordance with the present invention;

FIGS. 3A and 3B are block diagrams for illustrating how the validation process may be used to detect an installation problem some time after the software application is installed;

FIG. 4 is a block diagram illustrating the comparison between a validation manifest corresponding to a software application and the results obtained by the validation process from the computer upon which the software application is installed;

FIG. 5 is a pictorial diagram illustrating an exemplary networked environment suitable for validating the installation of a software application on networked computers in accordance with aspects of the present invention;

FIG. 6 is a flow diagram illustrating an exemplary routine for validating the installation of a software application on a computer; and

FIG. 7 is a flow diagram illustrating an exemplary routine for validating multiple software components installed on a computer.

### DETAILED DESCRIPTION

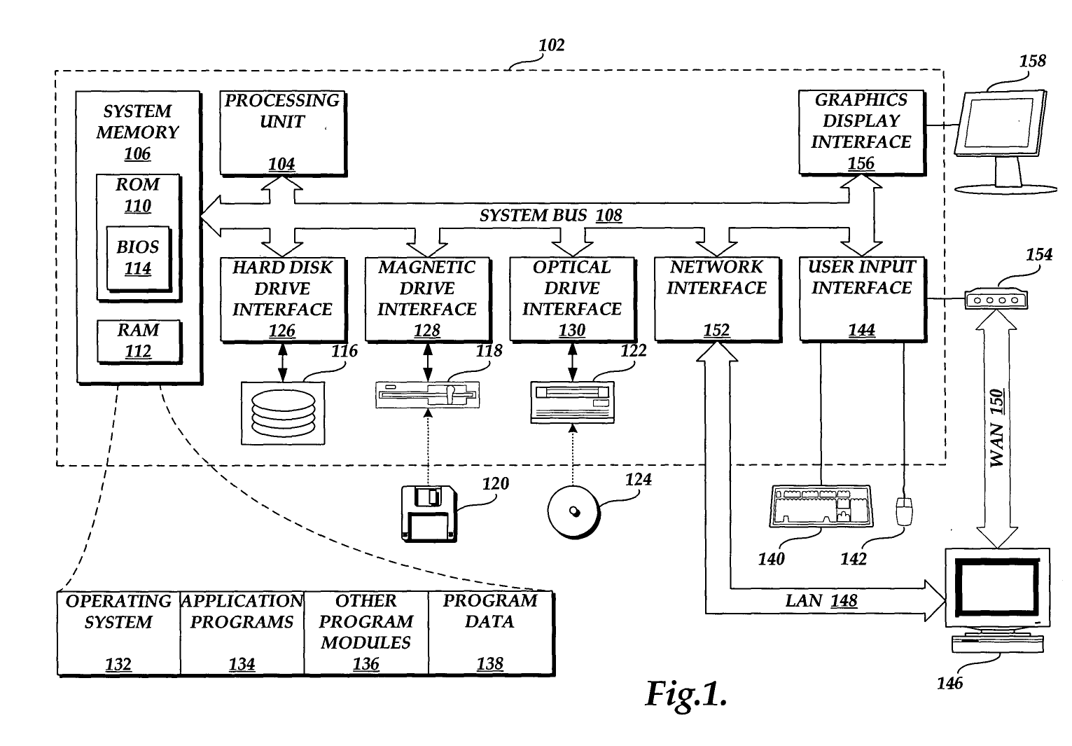

FIG. 1 and the following discussion are intended to provide a brief, general description of a computing system suitable for implementing various features of the invention. While the computing system will be described in the general context of a personal computer usable as a stand-alone computer, or in a distributed computing environment where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, and the like.

While aspects of the invention may be described in terms of application programs that run on an operating system in conjunction with a personal computer, those skilled in the art will recognize that those aspects also may be implemented in combination with other program modules. Generally, program modules include routines, programs, components, data structures, etc., that perform particular tasks or implement particular abstract data types.

With reference to FIG. 1, an exemplary system for implementing aspects of the invention includes a conventional personal computer 102, including a processing unit 104, a system memory 106, and a system bus 108 that couples the system memory to the processing unit 104. The system memory 106 includes read-only memory (ROM) 110 and random-access memory (RAM) 112. A basic input/output system 114 (BIOS), containing the basic routines that help to transfer information between elements within the personal computer 102, such as during startup, is stored in ROM 110.

The personal computer 102 further includes a hard disk drive 116, a magnetic disk drive 118, e.g., to read from or write to a removable disk 120, and an optical disk drive 122, e.g., for reading a CD-ROM disk 124 or to read from or write to other optical media. The hard disk drive 116, magnetic disk drive 118, and optical disk drive 122 are connected to the system bus 108 by a hard disk drive interface 126, a magnetic disk drive interface 128, and an optical drive interface 130, respectively. The drives and their associated computer-readable media provide nonvolatile storage for the personal computer 102. Although the description of computer-readable media above refers to a hard disk, a removable magnetic disk, and a CD-ROM disk, it should be appreciated by those skilled in the art that other types of media that are readable by a computer, including magnetic cassettes, flash memory cards, digital video disks, Bernoulli cartridges, ZIP disks, and the like, may also be used in the exemplary operating environment.

A number of program modules may be stored in the drives and RAM 112, including an operating system 132, one or more application programs 134, other program modules 136, and program data 138. A user may enter commands and information into the personal computer 102 through input devices such as a keyboard 140 or a mouse 142. Other input devices (not shown) may include a microphone, touch pad, joystick, game pad, satellite dish, scanner, or the like. These and other input devices are often connected to the processing unit 104 through a user input interface 144 that is coupled to the system bus, but may be connected by other interfaces (not shown), such as a game port or a universal serial bus (USB).

A display device 158 is also connected to the system bus 108 via a display subsystem that typically includes a graphics display interface 156 and a code module, sometimes referred to as a display driver, to interface with the graphics display interface. While illustrated as a stand-alone device, the display device 158 could be integrated into the housing of the personal computer 102. Furthermore, in other computing systems suitable for implementing the invention, such as a tablet computer, the display could be overlaid with a touch-screen. In addition to the elements illustrated in FIG. 1, personal computers also typically include other peripheral output devices (not shown), such as speakers or printers.

The personal computer 102 may operate in a networked environment using logical connections to one or more remote computers, such as a remote computer 146. The remote computer 146 may be a server, a router, a peer device, or other common network node, and typically includes many or all of the elements described relative to the personal computer 102. The logical connections depicted in FIG. 1 include a local area network (LAN) 148 and a wide area network (WAN) 150. Such networking environments are commonplace in offices, enterprise-wide computer networks, intranets, and the Internet. It should be appreciated that the connections between one or more remote computers in the LAN 148 or WAN 150 may be wired or wireless connections, or a combination thereof.

When used in a LAN networking environment, the personal computer 102 is connected to the LAN 148 through a network interface 152. When used in a WAN networking environment, the personal computer 102 typically includes a modem 154 or other means for establishing communications over the WAN 150, such as the Internet. The modem 154, which may be internal or external, is connected to the system bus 108 via the user input interface 144. In a networked environment, program modules depicted relative to the personal computer 102, or portions thereof, may be stored in the remote memory storage device. It will be appreciated that the network connections shown are exemplary and other means of establishing a communication link between the computers may be used. In addition, the LAN 148 and WAN 150 may be used as a source of nonvolatile storage for the system.

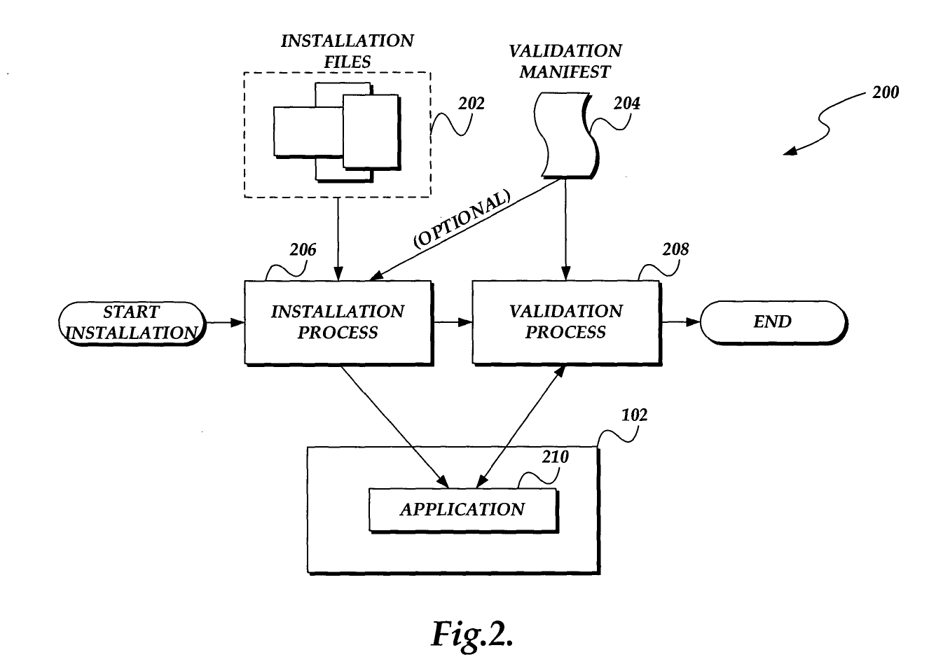

FIG. 2 is a block diagram illustrating an exemplary installation and validation process 200 of a software application according to aspects of the present invention. Initially, an installation process 206 obtains installation files 202 corresponding to an application 210. The installation process 206 uses the installation files to install the application 210 on the computer 102. Optionally, a validation manifest 204, doubling as an installation manifest, may assist the installation process 206 in installing the application 210 onto the computer 102. Installation manifests are known in the art, and generally provide installation directions to an installation process, such as installation process 206.

Those skilled in the art will readily recognize that a software application 210 is often comprised of numerous individually identifiable files, including executable modules, dynamically loadable libraries, image files, help files, data files, etc. Thus, it should be understood that while the present discussion refers to a software application 210 as a singular object, it is made as a logical reference to the software application, whether or not the software application is comprised of a single or multiple files.

A validation manifest, in accordance with the present invention, such as validation manifest 204, includes validation information that is used by a validation process 208 to determine whether the corresponding software application 210 is properly installed on the computer. Typically, the validation manifest is provided with the software application 210, or at least available from the software application's vendor. However, according to embodiments of the present invention, some part of the validation manifest may be user configurable. User-configurable validation manifests may be especially important and useful to system administrators to maintain, or enforce, system-wide installation configurations. Additionally, as already mentioned above, a validation manifest 204 may include installation information that an installation manifest would typically include.

The validation manifest 204 includes validation information comprised of validation actions, i.e., tokens and data representing instructions to the validation process 208 to be carried out on the computer 102 and/or software application 210, as well as any expected values or responses for actually determining whether the software application has been properly installed on the computer when the validation actions are carried out. Examples of validation actions carried out by the validation process 208 include, but are not limited to, the following: determining whether specific application files have been created and/or copied to specific locations on the computer 102; determining whether system registry entries have been created and/or set according to specific values, often provided in the validation manifest; determining that shared resources, such as shared libraries or modules, are up to date such that a correct version is installed on the computer; determining whether system environmental settings are properly set, such as search paths and system variables; executing validation/test programs supplied with the software application 210; calling validation/test routines within dynamically loadable libraries associated with the software application; performing check sums on installed files associated with the software application; and determining whether installed files associated with the software application are of the appropriate size and have a correct modification date. Those skilled in the art will recognize that any number of combinations of the above-listed validation actions, or other validation actions, may be placed in a validation manifest to verify that the software application is properly installed.

According to one embodiment, after determining whether the software application 210 is properly installed on the computer 102, the validation process 208 may report its determination and/or findings to the user. Alternatively, the validation process 208, or another cooperative process (not shown), may attempt to correct installation defects that are found during the validation process. For example, the validation process may use information in the validation manifest, such as the installation information described above, to determine what actions are required to correct any installation defects that have been detected.

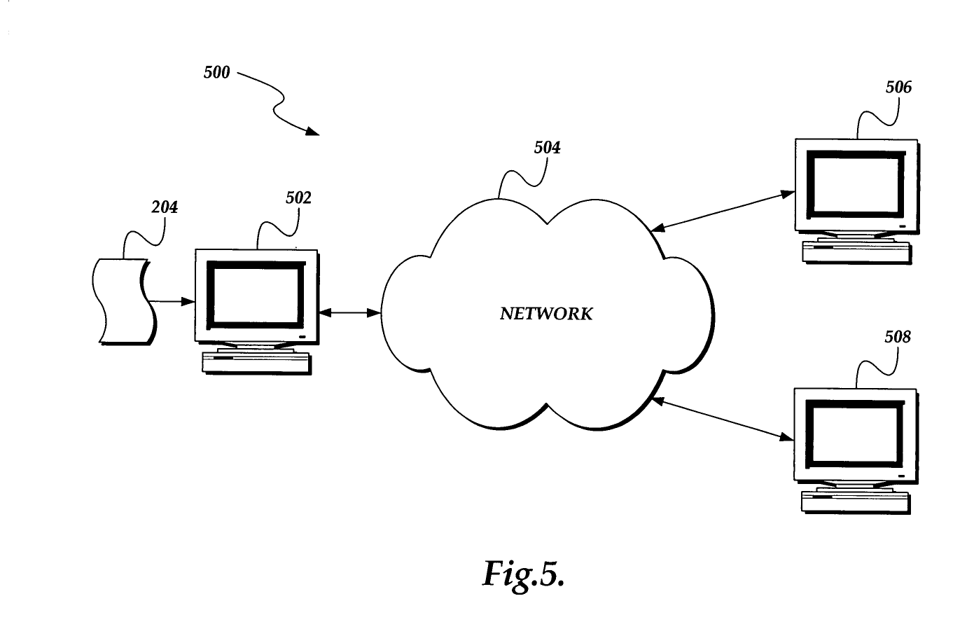

It should be understood that, while exemplary process 200 described above in regard to FIG. 2 includes a typical installation process 206 immediately prior to the validation process 208, it is for illustration purposes, and should not be construed as limiting upon the present invention. The validation process 208 may be executed against any suitable software application installed on the computer 102, whether or not the application was installed immediately prior to executing the verification process, or at some time substantially removed from its installation. For purposes of this description, a suitable software application is a software application whose installation can be verified using the validation process 208 discussed above. In fact, the verification process is beneficial to single users who are validating software installations, as well as to system administrators managing a network-wide array of computers, each having a suitable software application installed. A greater description of utilizing the present invention in a networked environment is described below in regard to FIG. 5.

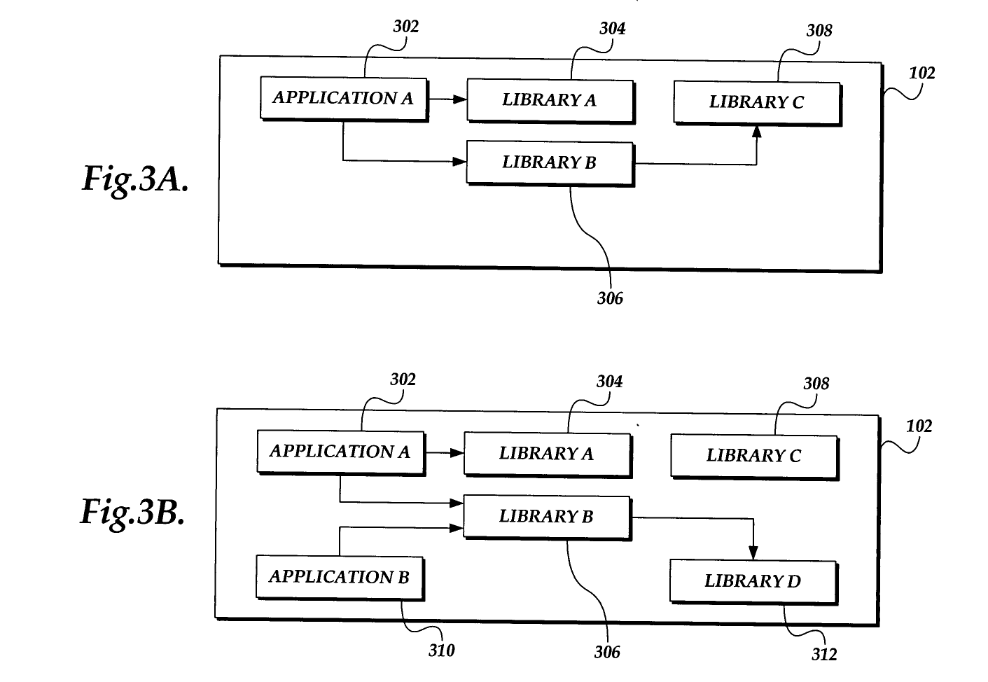

In regard to further understanding how the present invention may be used at some period of time after a suitable software application has been installed, FIGS. 3A and 3B illustrate a scenario that all too commonly occurs with the installation of multiple applications on a computer 102. For example, as shown in FIG. 3A, Application A 302 has been installed on the computer 102. As part of the installation of Application A 302, various libraries have also be installed, including Library A 304, Library B 306, and Library C 308. However, as shown in FIG. 3A, Application A 302 directly communicates only with Library A 304 and Library B 306. For this example, it is assumed that Library B 306 must obtain certain services from Library C 308 for Application A 302 to be properly installed and operate correctly. As shown in FIG. 3A, Application A 302 is properly installed on the computer 102.

With reference to FIG. 3B, at some point after Application A 302 is installed, Application B 310 is also installed on the computer 102. As part of the installation of Application B 310, Library B 306 and Library D 312 must be installed on the computer 102. Because Library B 310 is already installed, it is not “reinstalled” onto the computer 102. However, as part of the installation process for Application B 310, Library B 306 is directed to obtain services from the newly installed Library D 312. Thus, as shown in FIG. 3B, Application B 310 is properly installed. However, the installation of Application B 310 has “broken” the link between Library B 306 and Library C 308, which means that Application A 302 is no longer properly installed on the computer 102.

Because the validation process 208 (FIG. 2), described above, may be executed at any time after a software application is installed, and assuming that Application A 302 is a suitable software application, the validation process may be executed to determine if Application A is still properly installed on the computer 102. Thus, the validation manifest associated with Application A 302 may include a validation action for calling a validation routine in Library B 306 to query which other library provides services to it, and detect and report that Application A is no longer properly installed on the computer 102.

Those skilled in the art will recognize that the example described above in regard to FIGS. 3A and 3B represents just one example of how the validation process may be used to validate whether an application is installed properly on a computer 102. It should not, therefore, be construed as limiting upon the present invention. As mentioned above, a validation manifest 204 may be configured with any number validation actions and combinations thereof, to validate whether a software application is properly installed on a computer 102.

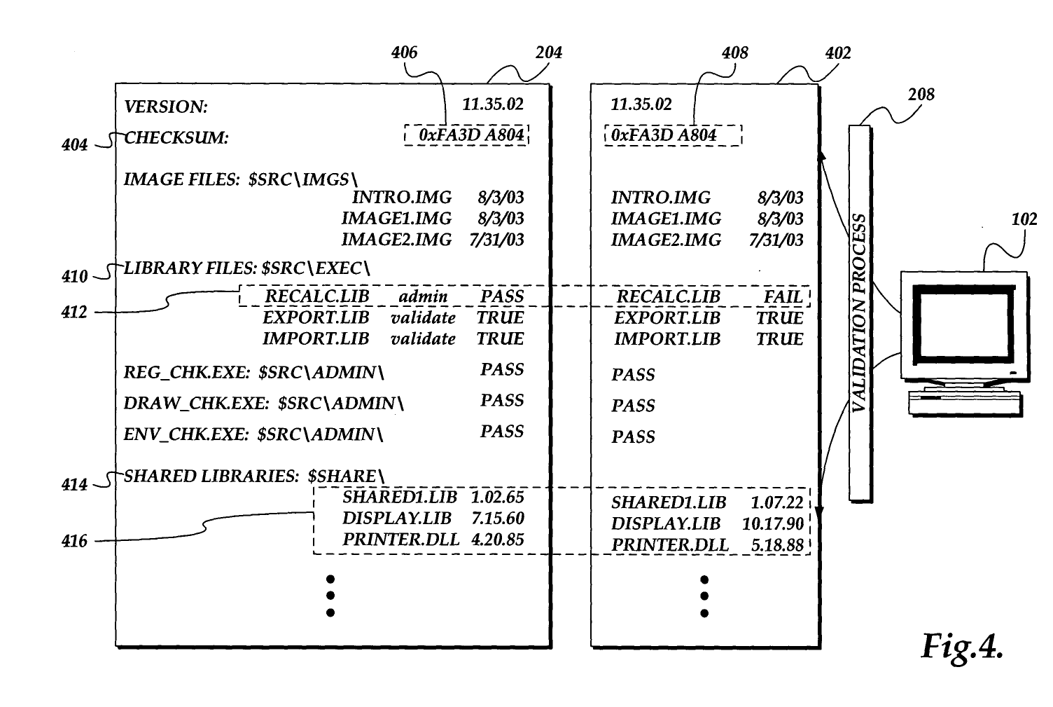

FIG. 4 is a block diagram illustrating aspects of an exemplary validation manifest 204, and further illustrating how the validation manifest may be used to determine whether a software application 210 is properly installed on the computer 102. As mentioned above, a validation manifest 204 may include a number of validation actions to be carried out to determine the validity of the software installation. In addition to the validation actions, other information may also be included, such as values to be used for testing, as well as expected results. For purposes of this example, text aligned on the left side of the validation manifest 204 represent validation actions, whereas text aligned to the right side of the validation manifest represent response results and/or other information used to validate the installation of the software application 210 on the computer 102. However, it should be understood that this format, as well as the text of the validation actions and responses, are illustrative only, and should not be construed as limiting upon the present invention.

As mentioned above, a validation process 208 obtains the validation manifest 204 and carries out the validation actions within. By monitoring the actual results of the validation actions, possibly comparing the actual results to expected results in the validation manifest 204, the validation process 208 determines whether the software application 210 is properly installed. For illustration purposes, box 402 represents the responses resulting from executing the validation actions. As shown in FIG. 4, the validation action Checksum 404 may cause a checksum operation to be performed on the software application's main executable program to determine whether the application has been properly copied to the computer 102. Also shown in the validation manifest is an expected results value 406 for the checksum operation. As shown in box 402, the actual results 408 coincide with the expected results 406, which would be an indication that, at least as far as the checksum operation can determine, the software application 210 is installed properly on the computer 102.

While one validation action may result in a positive test, the determination as to whether the software application 210 is properly installed on the computer 102 is determined by executing all of the validation actions in the validation manifest 204, or at least until a negative result is detected. According to one embodiment, it is necessary that all of the validation actions yield positive results in order for the validation process 208 to determine that the software application 210 is properly installed. Alternatively, executing validation actions may cease as soon as one, or a predetermined threshold, of validation actions yield a negative results. Thus, according to this embodiment, not all validation actions need yield a positive result in order for the validation process 208 to determine that the software application 210 is properly installed.

The validation action Library Files 412, for this example, represents instructions to enumerate library files in the director corresponding to “$SRC\EXEC\”, and the expected libraries to be found are listed. In addition to listing the libraries, a validation routine and an expected results generated by the validation routine are supplied, such as shown in box 412 showing RECALC.LIB as one of the libraries to be found, having a validation routine “admin”, and expecting a result of PASS when it is called. As also shown in the actual results, RECALC.LIB is found in the directory, but the call to the validation routine “admin” generated the result FAIL, indicating a problem exists with the library, and possibly the application 210 is not properly installed.

The validation action Shared Libraries 414 for this example, represents instructions to enumerate library files in the director corresponding to “$SHARE\”, and the expected libraries to be found are listed. Also listed are expected library version numbers. Those skilled in the art will recognize that, quite frequently, software applications require shared libraries with a minimal base version, but are tolerant of, or can operate with, later versions. Thus, as shown in box 416, all of the libraries listed in the expected results are found in the actual results, though the corresponding version numbers that are actually installed on the computer 102 are actually higher. In this case it is likely that the validation process 208 will qualify the enumeration and version numbers of all of the shared libraries as a positive result.

As previously mentioned, the verification process 208 may be beneficially utilized by network administrators, and others, to maintain and/or enforce system-wide standard installations. FIG. 5 is a pictorial diagram illustrating an exemplary networked environment 500 suitable for implementing aspects of the present invention. Thus, in an environment where a standard installation configuration is desired, an administrator on an administrator machine 502 may obtain a validation manifest 204 associated with an application 210 installed on one or more client computers, such as client computers 506 and 508. Through the network 502, such as, but not limited to, the WAN, LAN, or Internet described above, an administrator, from the administrator computer 502 may execute the validation process 208 to determine whether the application is properly configured and installed on the client computers and, if not, be able to take appropriate corrective actions. Such corrective actions may include reconfiguring application settings or environment variables, removing offending modules, adding missing modules, and the like. Corrective actions may also include causing the validation process to be executed for another installed application. Using this “chaining” of validation processes, complex installation or configuration problems may be resolved among any number of installed applications. Thus, according to one embodiment, the validation process 208 may be configured, in conjunction with information in the validation manifest 204, to correct configuration and/or installation problems detected on a computer, such as client computer 506 or 508. Thus, referring again to FIG. 3B, a validation manifest 204 associated with Application A 302 may include corrective actions that redirect Library B 306 to again reference Library C 308. Those skilled in the art will also recognize that including corrective actions in a validation manifest 204 is not limited to network environments. A single user may also wish correct installation problems that arise, all too commonly, after a period of usage/time.

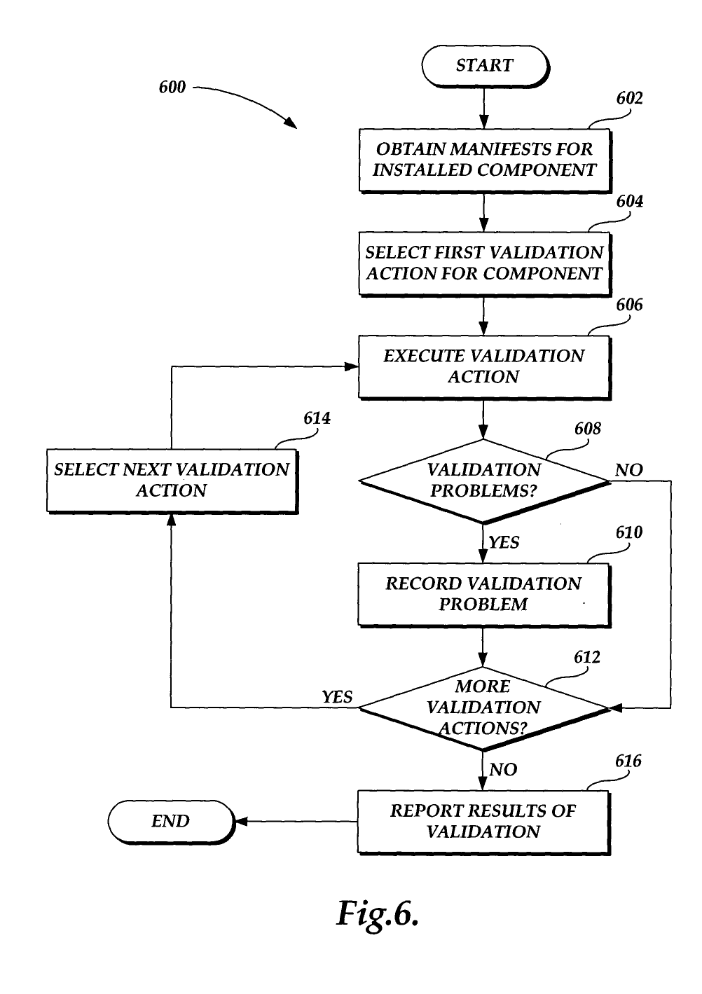

FIG. 6 is a flow diagram illustrating an exemplary routine 600 for validating the installation of a software application 210 on a computer 102. Beginning at block 602, a validation manifest 204 for a suitable software application 210 is obtained. At block 604, a first validation action for the application is obtained from the validation manifest 204. At block 606, the selected validation action is executed and/or carried out. At decision block 608, a determination is made in regard to the executed validation action whether there are any validation problems. As mentioned above, validation problems are determined by evaluating the results of the validation action. If, in response to the executed validation action, a validation problem is detected, at block 610, the results are recorded indicating that the validation problem exists.

After recording the detected validation problem, or, if there were no validation problems, at block 612, a determination is made as to whether there are any additional validation actions in the validation manifest 204 to be executed. If there are additional validation actions, at block 614, the next validation action in the validation manifest 204 is selected. The routine 600 then returns to block 606 where the selected validation action is executed. Routine 600 continues until, at block 612, a determination is made that there are no validation actions remaining in the validation manifest 204. Once no additional validation actions are to be executed, at block 616, the validation problems, if any, are reported. Thereafter, the routine 600 terminates.

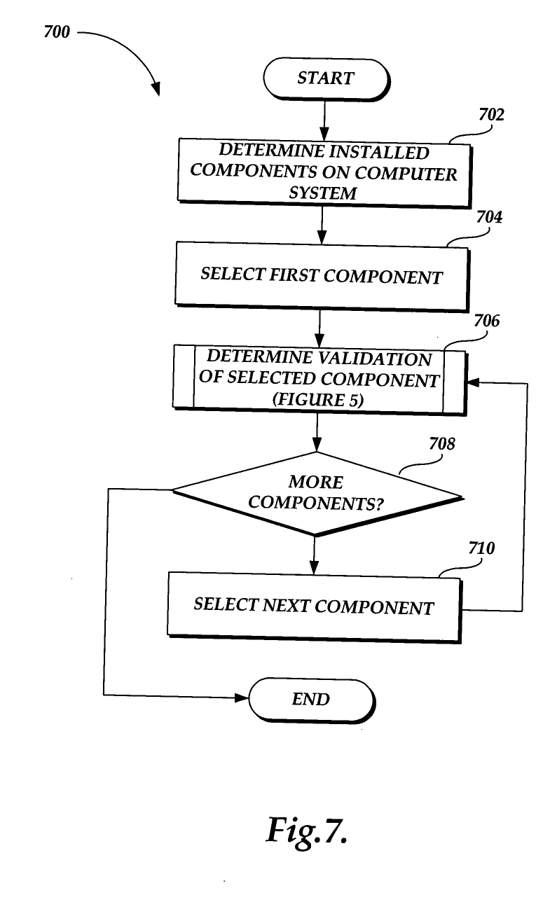

FIG. 7 is a flow diagram illustrating an exemplary routine 700 for validating multiple applications installed on a computer 102. Beginning at block 702, a determination is made as to which, if any, suitable applications are installed on the computer 102. At block 704, a first suitable application is selected. At block 706, it is determined whether the selected application is properly installed, using the exemplary routine 600 described above in regard to FIG. 6. At decision block 708, a determination is made as to whether there are any additional suitable applications installed on the computer 102. If there are additional applications to validate, at block 710, the next suitable application is selected. Thereafter, the routine 700 returns to block 706 where it is determined whether the selected application is properly installed. This routine 700 continues until at block 708, no additional applications are to be validated. Thereafter, the process terminates.

While the preferred embodiment of the invention has been illustrated and described, it will be appreciated that various changes can be made therein without departing from the spirit and scope of the invention.

1. A computer-implemented method for determining whether a software application is properly installed on target computer, comprising:
obtaining a validation manifest associated with the software application, the validation manifest comprising validation actions for determining whether the software application is properly installed on the target computer;
executing the validation actions in the validation manifest; and
based on the results of the executed validation actions, determining whether the software application is properly installed on the target computer.

2. The method of claim 1, wherein the validation actions comprise a validation program associated with the software application that, when executed, returns results indicating whether aspects of the software application are properly installed on the target computer.

3. The method of claim 1, wherein the validation actions comprise a validation routine in a loadable module associated with the software application that, when called, returns results indicating whether aspects of the software application are properly installed on the target computer.

4. The method of claim 1, wherein the validation actions comprise a comparison instruction to compare an aspect of the software application to corresponding validation response information in the validation manifest.

5. The method of claim 4, wherein the aspect of the software application compared by the comparison instruction is the modification date of a file provided as part of the software application.

6. The method of claim 4, wherein the aspect of the software application compared by the comparison instruction is the file size of a file provided as part of software application.

7. The method of claim 4, wherein the aspect of the software application compared by the comparison instruction is the version number of a shared library module used by the software application.

8. The method of claim 4, wherein the aspect of the software application compared by the comparison instruction is the version number of a library module provided as part of the software application.

9. The method of claim 4, wherein the aspect of the software application compared by the comparison instruction is a system registry associated with the software application.

10. The method of claim 4, wherein the aspect of the software application compared by the comparison instruction is a system environment setting.

11. The method of claim 1, wherein the validation manifest further comprises installation information for installing the software application on the target computer.

12. The method of claim 1 further comprising, upon detecting a negative result from executing a validation action, executing a corrective action associated with the validation action.

13. A system for validating whether a software component is properly installed on a target computer, the system comprising:
a processor; and
a memory, the memory storing and software application, and further storing a validation module, wherein the validation module:
obtains a validation manifest associated with the software application, the validation manifest comprising at least one validation action for determining whether the software application is properly installed on the target computer;
executes the validation actions in the validation manifest; and
based on the results of the executed validation actions, determines whether the software application is properly installed on the target computer.

14. The system of claim 13, wherein the at least one validation action comprises a validation program associated with the software application that, when executed, returns results indicating whether aspects of the software application are properly installed on the target computer.

15. The system of claim 13, wherein the at least one validation action comprises a validation routine in a loadable library associated with the software application that, when called, returns results indicating whether aspects of the software application are properly installed on the target computer.

16. The system of claim 13, wherein the at least one validation action comprises a comparison instruction to compare an aspect of the software application to corresponding validation response information in the validation manifest.

17. The system of claim 16, wherein the aspect of the software application compared by the comparison instruction is the modification date of a file provided as part of the software application.

18. The system of claim 16, wherein the aspect of the software application compared by the comparison instruction is the file size of a file provided as part of software application.

19. The system of claim 16, wherein the aspect of the software application compared by the comparison instruction is the version number of a shared library module used by the software application.

20. The system of claim 16, wherein the aspect of the software application compared by the comparison instruction is the version number of a library module provided as part of the software application.

21. The system of claim 16, wherein the aspect of the software application compared by the comparison instruction is a system registry associated with the software application.

22. The system of claim 16, wherein the aspect of the software application compared by the comparison instruction is a system environment setting.

23. The system of claim 13, wherein the validation manifest further comprises installation information for installing the software application on the target computer.

24. The system of claim 13, wherein the validation module, upon detecting a negative result from executing a validation action, executes a corrective action associated with the validation action.

25. A networked computing environment for validating whether a software application is properly installed on a client computer, the system comprising:
a client computer upon which the software application is installed; and
an administrator computer, the administrator computer operable to:
obtain a validation manifest relating to the software application, the validation manifest comprising validation actions for determining whether the software application is properly installed on the client computer;
carry out the validation actions in the validation manifest; and
based on the results of carrying out the validation actions, determine whether the software application is properly installed on the client computer.

26. The networked computing environment of claim 25, wherein the validation actions comprise a validation program associated with the software application which, when executed, returns results indicating whether aspects of the software application are properly installed on the client computer.

27. The networked computing environment of claim 25, wherein the validation actions comprise a validation routine in a loadable library on the client computer associated with the software application which, when called, returns results indicating whether aspects of the software application are properly installed on the client computer.

28. The networked computing environment of claim 25, wherein the validation actions comprise a comparison instruction to compare an aspect of the software application installed on the client computer to corresponding validation response information in the validation manifest.

29. The networked computing environment of claim 28, wherein the aspect of the software application compared by the comparison instruction is the modification date of a file on the client computer installed as part of the software application.

30. The networked computing environment of claim 28, wherein the aspect of the software application compared by the comparison instruction is the file size of a file installed as part of software application.

31. The networked computing environment of claim 28, wherein the aspect of the software application compared by the comparison instruction is the version number of a shared library module used by the software application.

32. The networked computing environment of claim 28, wherein the aspect of the software application compared by the comparison instruction is the version number of a library module installed as part of the software application.

33. The networked computing environment of claim 28, wherein the aspect of the software application compared by the comparison instruction is a system registry on the client computer associated with the software application.

34. The networked computing environment of claim 28, wherein the aspect of the software application compared by the comparison instruction is an system environment setting on the client computer.

35. The networked computing environment of claim 25, wherein the validation manifest further comprises installation information for installing the software application on the client computer.

36. The networked computing environment of claim 25, wherein the administrator computer is further operable to, upon detecting a negative result from executing a validation action, execute a corrective action associated with the validation action.

37. A computer-readable medium having computer-readable instructions which, when executed, carry out the method comprising:
obtaining a validation manifest associated with the software application, the validation manifest comprising validation actions for determining whether the software application is properly installed on the target computer;
executing the validation actions in the validation manifest; and
based on the results of the executed validation actions, determining whether the software application is properly installed on the target computer.

38. The method of claim 37, wherein the validation actions comprise a validation program associated with the software application that, when executed, returns results indicating whether aspects of the software application are properly installed on the target computer.

39. The method of claim 37, wherein the validation actions comprise a validation routine in a loadable module associated with the software application that, when called, returns results indicating whether aspects of the software application are properly installed on the target computer.

40. The method of claim 37, wherein the validation actions comprise a comparison instruction to compare an aspect of the software application to corresponding validation response information in the validation manifest.

41. The method of claim 40, wherein the aspect of the software application compared by the comparison instruction is the modification date of a file provided as part of the software application.

42. The method of claim 40, wherein the aspect of the software application compared by the comparison instruction is the file size of a file provided as part of software application.

43. The method of claim 40, wherein the aspect of the software application compared by the comparison instruction is the version number of a shared library module used by the software application.

44. The method of claim 40, wherein the aspect of the software application compared by the comparison instruction is the version number of a library module provided as part of the software application.

45. The method of claim 40, wherein the aspect of the software application compared by the comparison instruction is a system registry associated with the software application.

46. The method of claim 40, wherein the aspect of the software application compared by the comparison instruction is a system environment setting.

47. The method of claim 37, wherein the validation manifest further comprises installation information for installing the software application on the target computer.

48. The method of claim 37 further comprising, upon detecting a negative result from executing a validation action, executing a corrective action associated with the validation action.

49. A computer implemented method for determining whether a plurality of software applications are properly installed on a target computer, the method comprising:
identifying a plurality of software applications installed on the target computer; and
for each identified software application:
obtaining a validation manifest associated with the software application, the validation manifest comprising validation actions for determining whether the software application is properly installed on the target computer;
executing the validation actions in the validation manifest; and
based on the results of the executed validation actions, determining whether the software application is properly installed on the target computer.
